(19) United States
(12) Patent Application Publication
(10) Pub. No.: US 2016/0046143 A1
(43) Pub. Date: Feb. 18, 2016

(54) Method for promoting silk flowers with sports team emblems

(71) Applicant: Vincent A. Concordia, III, Chalfont, PA (US)

(72) Inventor: Vincent A. Concordia, III, Chalfont, PA (US)

(21) Appl. No.: 14/460,840

(22) Filed: Aug. 15, 2014

(51) Int. Cl. B44C 1/10; B44C 1/16; A41G 1/00

(52) U.S. Cl. CPC B44C 1/10; A41G 1/00; B44C 1/16

(57) ABSTRACT

A series of business methods, processes, and results incorporates licensing popular and readily identified sports-related trademarks and copyrighted images, and uses these images in the production of silk flowers. The method of the invention incorporates a device that will incorporate a silk flower with the image of a popularly identifiable figure, such as a sports mascot or emblem, or a player in a sports uniform on it. The popularly identifiable figure would be a trademark or copyrighted image from a popular sports team, and the trademark or copyrighted image would be licensed for production as part of a licensing agreement. The flowers are composed of fabric such as silk, rayon, cotton or similar material. Various team emblems, mascots and sports figures, in different team colors, would be affixed to the petals and leaves in the form of decals, heat transfer printing, or other processes.

### CROSS-REFERENCE TO RELATED APPLICATIONS

Not Applicable

### STATEMENT REGARDING FEDERALLY SPONSORED RESEARCH OR DEVELOPMENT

Not Applicable

### PARTIES TO A JOINT RESEARCH AGREEMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

The invention relates generally to silk flowers, and in particular to silk flowers, whose appeal and marketability are enhanced by being decorated with copies of an image of a widely recognized sports logo or mascot. Sports enthusiasts are eager to show their support for their favorite sports, and in particular their favorite teams, by decorating portions of their indoor and outdoor living spaces with sporting related paraphernalia. Also, for the family and friends of sports enthusiast, finding an appropriate gift may be challenging. Making silk flowers decorated with favorite sports mascots and emblems, players in sports uniforms and other symbols, would help to fulfill the demand by sports enthusiasts and help his family and friends find the perfect gift. The invention is a series of business methods, processes, and results that license popular and readily identified sports-related trademarks and copyrighted images, and use these trademarks and images in the production of silk flowers.

### SUMMARY OF THE INVENTION

Accordingly, the invention is directed to a series of business methods, processes, and results that license popularly recognizable indicia such as popular and readily identified sports-related indicial, including related trademarks and copyrighted images, and uses these trademarks and copyrighted images in the production of silk flowers. The method of the invention incorporates a device that will preferably incorporate a silk flower with the image of a popularly identifiable figure, such as a sports mascot or emblem, or a player in a sports uniform on it. The popularly identifiable figure would be a trademark or copyrighted image from a popular sports team, and the trademark or copyrighted image would be licensed for production as part of a licensing agreement. Preferably, the sports team or university would enjoy advertisement for their organization any time the device was displayed. The flowers are preferably composed of fabric such as silk, rayon, cotton or similar material. Preferably, various team emblems, mascots and sports figures, in different team colors, would be affixed to the petals and leaves in the form of decals, heat transfer printing, or other processes.

Additional features and advantages of the invention will be set forth in the description which follows, and will be apparent from the description, or may be learned by practice of the invention. The foregoing general description and the following detailed description are exemplary and explanatory and are intended to provide further explanation of the invention.

### BRIEF DESCRIPTION OF THE DRAWINGS

No drawing is provided for the disclosed invention because a drawing is not necessary for the understanding of the invention under 35 U.S.C. §113, 37 §1.81(a), and MPH § 608.02 (III) (A).

### DETAILED DESCRIPTION OF THE INVENTION

Referring now to the invention in more detail, the invention is directed to a series of business methods, processes, and results that license popular and readily identified sports-related trademarks and copyrighted images, and uses these trademarks and copyrighted images in the production of silk flowers. The method of the invention incorporates a device that will preferably provide a decorated silk flower with copies of an image of a widely recognized sports logo or mascot. The silk flowers are preferably manufactured from fabric such as silk, rayon, cotton or similar materials, and wire. Preferably, the fabric is die-cut into the various flower petal shapes and sizes, and then dyed into the appropriate colors (including, optionally, the colors of a related sports team). To replicate the look of natural flowers, the silk flower petals need wrinkles and shapes. The petals are heat pressed in molds, which create a realistic appearance. The flower petals are then preferably affixed to wire that has the appropriate covering to make it appear to be the stem, then fabric leaves manufactured in the same way as the petals are affixed to the fabric covered wire that represents the stem of the flower. After producing single silk flowers, many single flowers are joined by hand to create recognizable sprays or bouquets.

Preferably, various team emblems, mascots and sports figures, in different team colors, would be affixed to the petals and leaves in the form of decals, heat transfer printing or other processes. The various indicia and petal color schemes may be applied to individual flowers or petals, or may be applied across the bouquet as a whole, with only a part of the image applied to each flower or petal. The popularly identifiable image affixed to the petals and leaves would be a trademark or copyrighted image from a popular sports team, and the trademark or image would be licensed for production as part of the business methods and processes. Preferably, the sports team or university would enjoy advertisement for their organization any time the device was displayed.

Teams favored in certain regions of the United States would have silk flower arrangements in corresponding team colors, and with a corresponding image of a widely recognized sports logo or mascot, manufactured and marketed to sports enthusiasts in their respective geographic regions. The device would preferably incorporate trademarked and copyrighted mascots and popularly identifiable figures from all levels of sports; from amateur to professional, licensing trademarked and copyrighted images and paying royalties to universities and professional sports franchises owning these trademarks and copyrights. Such licenses and royalties would be negotiated with the owning entities.

Each entity represented by the images would enjoy advertisement in places it normally would not traditionally promote itself. Because silk flowers are popular to display in high visibility areas, each entity could reach large numbers of sports enthusiasts that it normally would not reach. Unlike other decorations that have limited periods for display, these silk flowers could be displayed all year and would have no specific time period limiting their display. The silk flowers could be marketed to specific sports enthusiasts through websites, television, radio, print periodicals, and mail order, in department and specialty stores, and at stadiums, baseball parks, basketball arenas and other sporting venues.

Business methods and practices listed above are preferable, but artisans will recognize that different business methods and practices could be employed without altering the scope of the invention.

While the foregoing written description of the invention enables one of ordinary skill to make and use what is presently considered to be the best mode thereof, those of ordinary skill in the art will understand and appreciate the existence of variations, combinations, and equivalents of the specific embodiment, method, and examples herein. The invention should, therefore, not be limited by the above described embodiment, method, and examples, but by all embodiments and methods within the scope and spirit of the invention.

I claim:

1. A method of promotion of silk flowers comprising providing a silk flower having a plurality of artificial petals; said artificial petals being affixed to an artificial stem; obtaining a license to use popularly recognizable indicia, and applying said popularly recognizable indicia to said plurality of petals.

2. The method of promotion of silk flowers of claim 1 wherein said popularly recognizable indicia relate to a sports team.

3. The method of promotion of silk flowers of claim 2 wherein said petals are colored according to the colors of said sports team.

4. The method of promotion of silk flowers of claim 1 further comprising providing a bouquet, said bouquet comprising a plurality of said silk flowers.

5. The method of promotion of silk flowers of claim 4 wherein said popularly recognizable indicia relate to a sports team.

6. The method of promotion of silk flowers of claim 5 wherein said petals are colored according to the colors of said sports team.

7. The method of promotion of silk flowers of claim 4 wherein said popularly recognizable indicia are applied across said bouquet such that each individual one of said silk flowers of said bouquet bears only a portion of said popularly recognizable indicia.

8. The method of promotion of silk flowers of claim 5 wherein said popularly recognizable indicia are applied across said bouquet such that each individual one of said silk flowers of said bouquet bears only a portion of said popularly recognizable indicia.

9. The method of promotion of silk flowers of claim 6 wherein said popularly recognizable indicia are applied across said bouquet such that each individual one of said silk flowers of said bouquet bears only a portion of said popularly recognizable indicia.
